(19) United States
(12) Patent Application Publication
(10) Pub. No.: US 2008/0232190 A1
(43) Pub. Date: Sep. 25, 2008

(54) Mixing Element, Arrangement Comprising a Mixing Element and Mixer

(75) Inventor: Gottlieb Schneider, Seuzach (CH)

Correspondence Address: FISH & ASSOCIATES, PC;ROBERT D. FISH, 2603 Main Street, Suite 1050, Irvine, CA, 92614-6232, US

(73) Assignee: STAMIXCO TECHNOLOGY AG, Dinhard (CH)

(21) Appl. No.: 12/064,008

(22) PCT Filed: Jul. 18, 2006
(86) PCT No.: PCT/EP2006/064374

§ 371 Date: Feb. 15, 2008

(30) Foreign Application Priority Data
Aug. 18, 2005 (EP) 05107611.5

(51) Int. Cl. B01F 5/06

(52) U.S. Cl. 366/337

(57) ABSTRACT

The invention relates to a mixing element (1) which is used to invert and mix flowing materials in a flow channel. Said mixing element comprises an axially-symmetrical base body (1a) which has a longitudinal axis (A). The base body (1a) comprises an outward-facing surface (1k) in relation to the longitudinal axis (A) and a front surface (Im) on each end of the longitudinal axis (A), in addition to a plurality of guiding elements (1b), which are rigidly connected to the base body (1a) on the surface (1k) via a base surface (1l). The guiding elements (1b) extend in a transversal manner in relation to the longitudinal axis (A), such that each guiding element (1b) comprises an inward-facing guiding surface (1d) in relation to the longitudinal axis (A) and an outward-facing guiding surface (1c) in relation to the longitudinal axis (A). A plurality of guiding elements (1b) are arranged in a successive manner in the direction of the periphery (A1) of the longitudinal axis (A).

The invention relates to a mixing element in accordance with the preamble of claim 1. Furthermore, the invention relates to a set of components with mixing elements in accordance with the preamble of claim 11. The invention further relates to a mixer in accordance with the preamble of claim 14.

The document EP 0063729 discloses an apparatus for the inverting and mixing of flowing materials in a tube having at least one mixing element. The mixing element consists of guiding surfaces which are arranged such that fluid elements flowing at the centre of the tube are transported outwardly and fluid elements flowing outwardly are transported inwardly which is also termed a flow inversion or briefly inverting. This inverting permits an intensive through-mixing across the entire tube cross-section and also improves, if required, the heat transfer from a heated or cooled tube wall and the flowing fluid. The apparatus disclosed in the named document with mixing elements has the disadvantages that this only permits inverting mixing and in that the mixing elements are designed so that they are very subject to injury so that they can be easily damaged. Particularly disadvantageous is the fact that a long-term reliable operation for a mixer having a plurality of mixing elements arranged one after the other is not ensured, in particular when high pressure drops result in the axial direction through the fluid to be mixed.

It is the object of the present invention to propose more advantageous mixing elements, a more advantageous mixer and also a more advantageous mixing process.

This object is satisfied with a mixing element having the features in accordance with claim 1. The subordinate claims 2 to 10 relate to further advantageously designed mixing elements. The object is further satisfied with a set of components with mixing elements having the features of claim 11. The subordinate claims 12 to 13 relate to further advantageous sets of components. The object is further satisfied with a mixer having the features of claim 14. The subordinate claims 15 to 19 relate to further advantageous mixers, in particular also dynamic mixers. The object is further satisfied with a mixing method having the features of claim 20. Claim 21 relates to a further advantageous method.

The object is in particular satisfied with a mixing element for the inversion and mixing of flowing materials in a flow channel including an axially symmetrical base body having a longitudinal axis, with the base body having a surface facing outwardly with respect to the longitudinal axis and also an end face at each end of the longitudinal axis as well as a plurality of guiding elements which are firmly connected to the base body at the surface via a foot area, wherein the guiding elements extend obliquely to the longitudinal axis so that each guiding element has an inwardly facing guiding surface with respect to the longitudinal axis and an outwardly facing guiding surface with respect to the longitudinal axis and wherein a plurality of guiding elements are arranged following one another in the peripheral direction of the longitudinal axis. Depending on the direction of inclination of the guiding elements with respect to the longitudinal axis the flowing material is directed from the outer wall radially inwardly towards the longitudinal axis or from the inside radially towards the outer wall and in this mixes the material flow, or the fluid flow in the radial direction. A further through-mixing takes place behind each bar through the pressure difference resulting between the leading side and the trailing side of each guiding element, which leads in the case of turbulent flow to the formation of eddies and in the case of laminar flow to a transverse flow along the rear side or the trailing side of the guiding element.

The end faces of the mixing elements are designed such that at least two mixing elements can be arranged after one another in the direction of extent of the longitudinal axis in such a way that mutually contact at the end face. The mixing elements advantageously have connecting means in order to mutually connect two mixing elements in each case and advantageously to hold them in a defined mutual position.

In an advantageous embodiment the mixing elements have adjacently arranged guiding elements in a peripheral direction which alternately extend with an acute angle and an obtuse angle to the longitudinal axis with, in each case, two neighbouring elements in the peripheral direction having foot areas spaced apart in the direction of the longitudinal axis. A trans-verse opening arises between these foot areas which brings about a trans-verse flow in the peripheral direction to the longitudinal axis, so that the flowing fluid has a transverse flow at least at this point which produces a further mixing effect. This mixing element in accordance with the invention thus has two different mixing actions, a mixing in the peripheral direction to the longitudinal direction and also, brought about by the inclined extent of the mixing elements, a mixing in the radial direction to the longitudinal axis.

The mixing elements can be manufactured in a multitude of geometrical embodiments and can be differently designed for example with respect to diameter, number of the guiding elements, width of the guiding elements or gradient angle of the guiding elements. With a set of components comprising a plurality of mixing elements designed in this way and also comprising a flow passage or a plurality of differently designed flow passages, a multitude of different mixers with the most diverse mixing characteristics can be put together. This enables a flexible assembly of mixers which can be differently constructed depending of the fluid that is used and the mixing behaviour that is aimed at and can thereby each be ideally matched to the mixing task to be satisfied. In this connection liquids, gases or solid materials capable of trickling flow and also one or multiphase mixtures of fluid components with the same or greatly differing viscosities, gaseous and/or solid components are to be understood under the term fluid or flowing substances.

In an advantageous embodiment a plurality of mixing elements is arranged on a common carrier.

A distinction can be made between a static mixer and a dynamic mixer. The static mixer includes mixing elements which are fixedly and immovably arranged in the mixer. The dynamic mixer includes mixing elements which are movably arranged in the mixer. In an advantageous embodiment the mixing elements within a dynamic mixer are rotatably mounted about a common axis, in particular about the longitudinal axis. This rotation brings about an additional stretching of the fluid in the peripheral direction i.e. in the direction of rotation of the longitudinal axis.

The invention will be described in detail with reference to a plurality of embodiments which merely show a selection from a multitude of possible embodiments. There are shown:

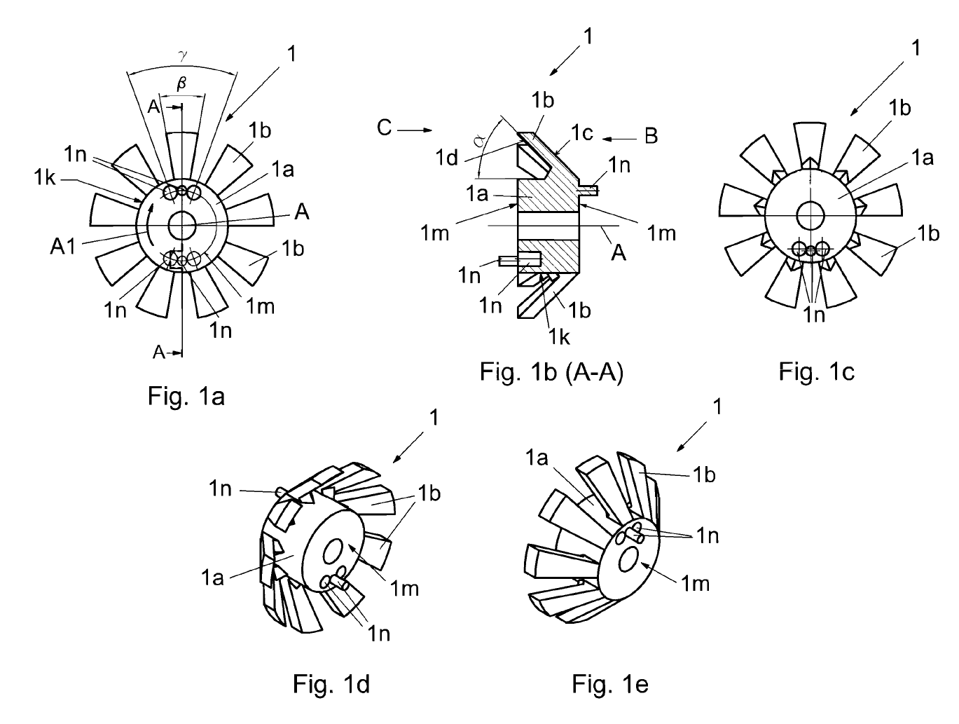

FIG. 1a a view of the front side of the mixing element from the direction of viewing B;

FIG. 1b a longitudinal section through the mixing element in accordance with FIG. 1a along the section line A-A;

FIG. 1c a view of the rear side of the mixing element from the viewing direction C;

FIG. 1d a perspective view of the rear side;

FIG. 1e a perspective view of the front side;

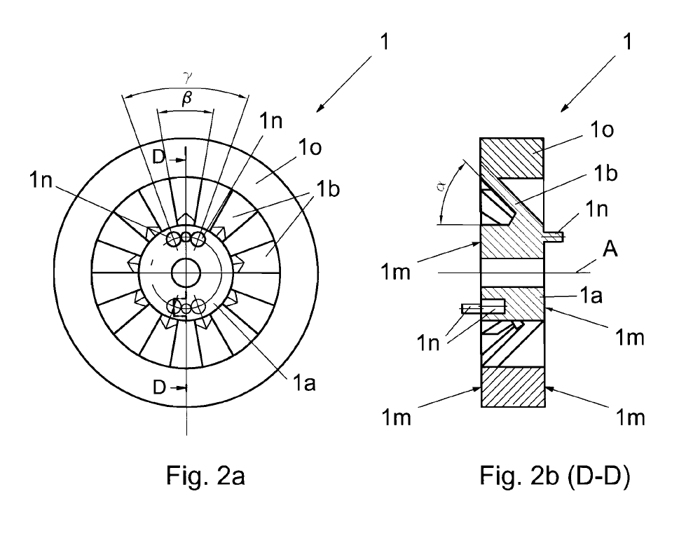

FIG. 2a a view of the front side of a further mixing element with reinforcing ring on the outer side;

FIG. 2b a section through the mixing element shown in FIG. 2a along the section line D-D;

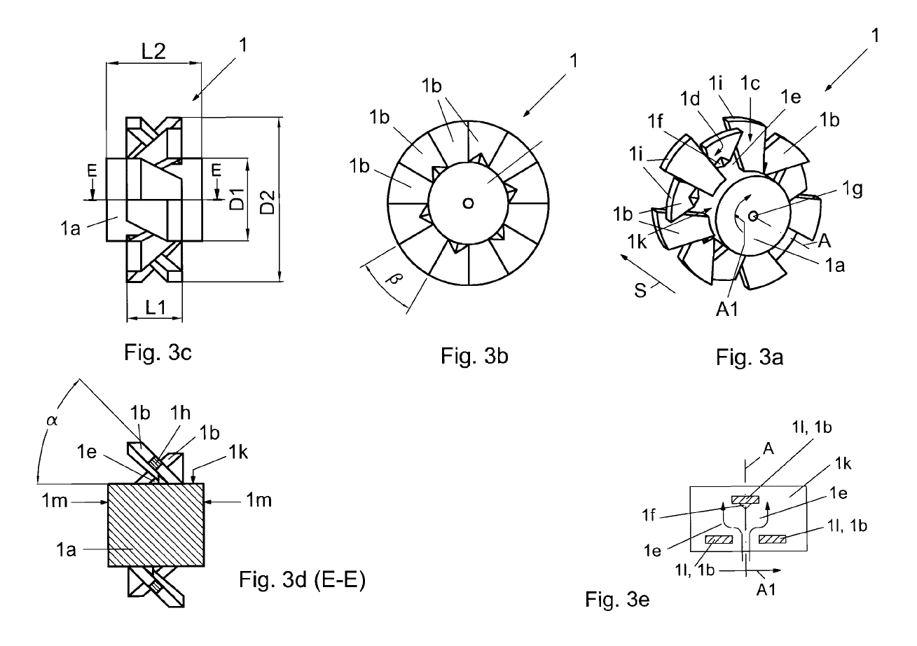

FIG. 3a a perspective view of a further mixing element;

FIG. 3b a view of the front side of the mixing element in accordance with FIG. 3a;

FIG. 3c a side view of the mixing element in accordance with FIG. 3a;

FIG. 3d a section through the mixing element shown in FIG. 3a along the section line E-E;

FIG. 3e a plan view on the surface of a mixing element in accordance with FIG. 3a;

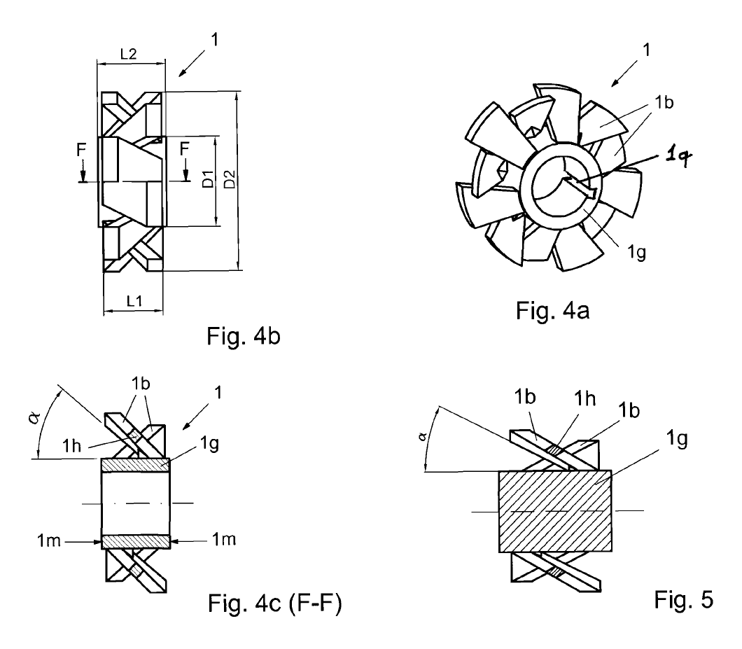

FIG. 4a a perspective view of a further mixing element;

FIG. 4b a side view of the mixing element in accordance with FIG. 4a;

FIG. 4c a longitudinal section through the mixing element in accordance with FIG. 4a along the section line F-F;

FIG. 5 a section through a further embodiment of a mixing element;

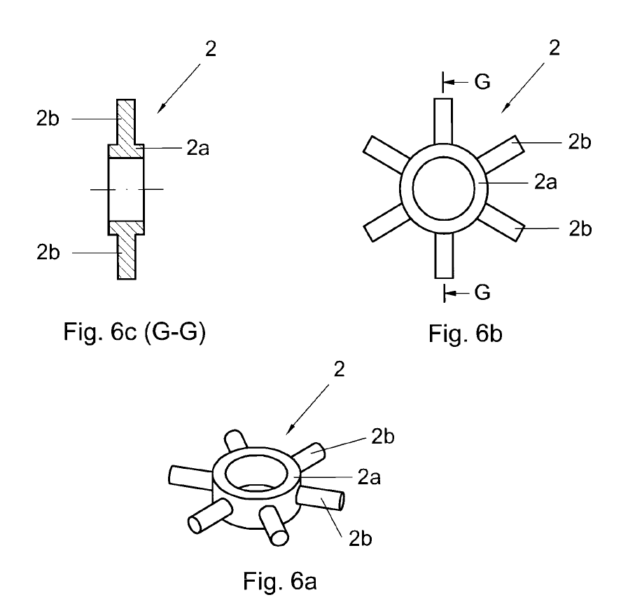

FIG. 6a a perspective view of a support part or an stretching element;

FIG. 6b a side view of the support part or of the stretching element;

FIG. 6c a longitudinal section through the support part of the stretching element in accordance with FIG. 6b along the section line G-G;

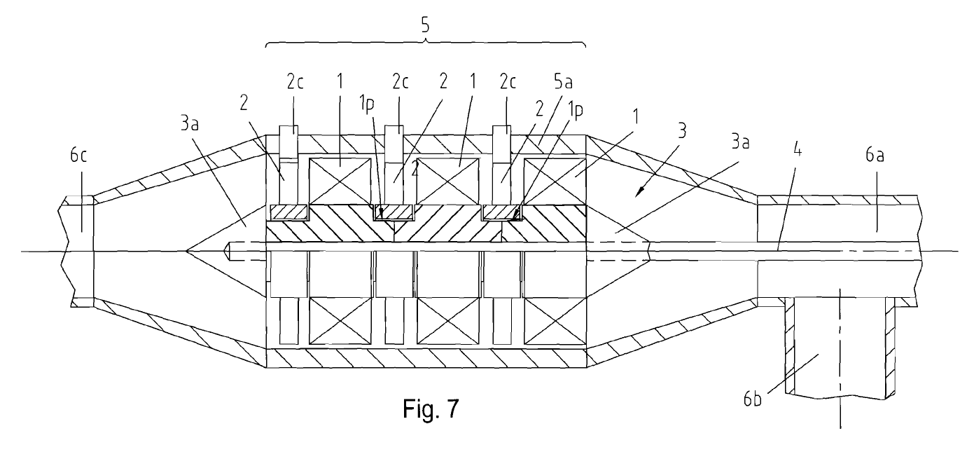

FIG. 7 a longitudinal section through a dynamic mixer;

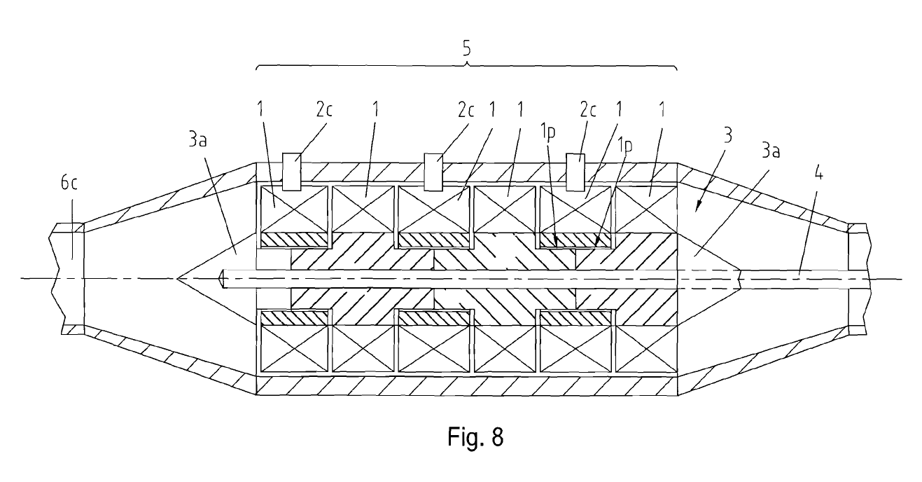

FIG. 8 a longitudinal section through a further embodiment of a dynamic mixer;

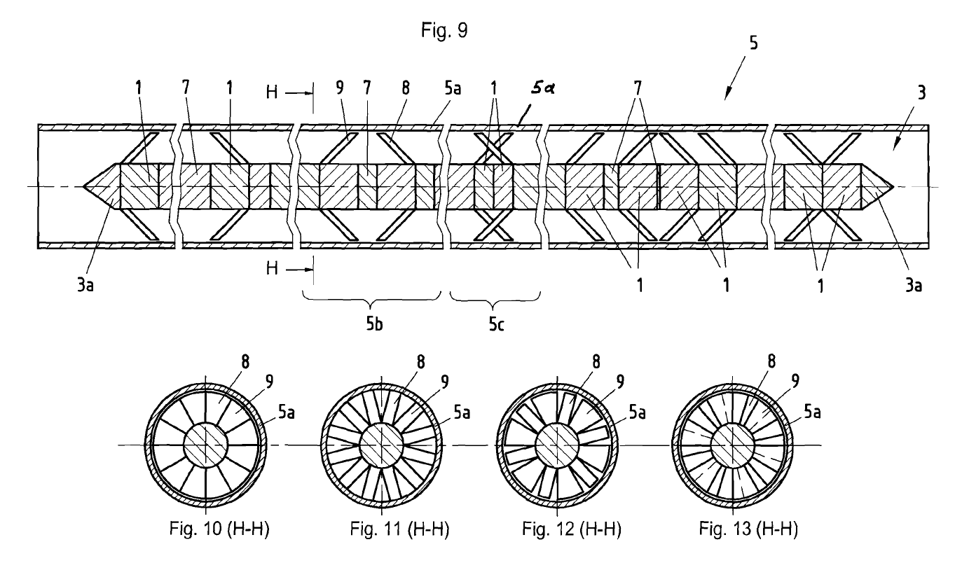

FIG. 9 a longitudinal section through a further embodiment of a mixer;

FIGS. 10 to 13 in each case a cross-section through the mixer in accordance with FIG. 9 along the section line H-H with embodiments of mixing elements;

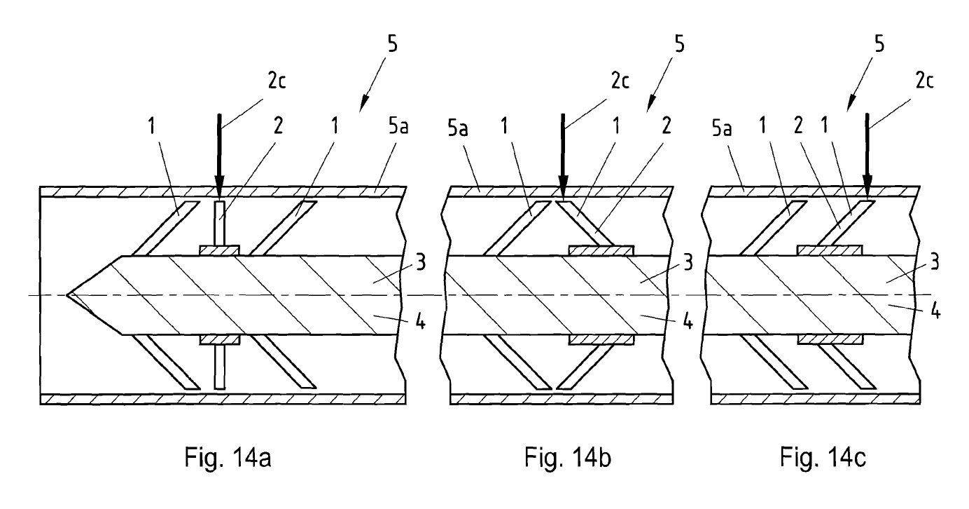

FIGS. 14a to 14c in each case a portion of a longitudinal section through a dynamic mixer with rotatable mixing elements and static support and/or stretching element;

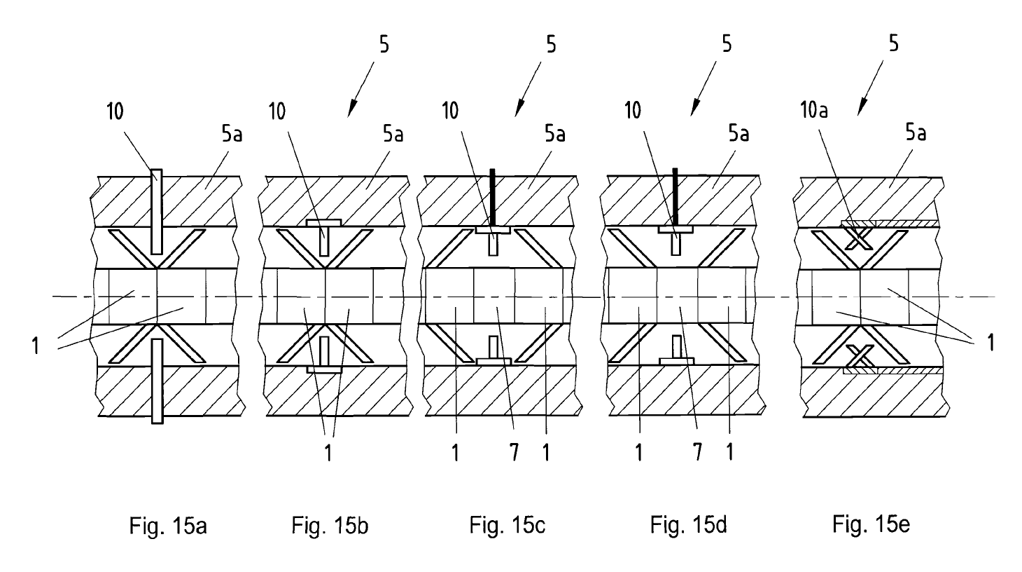

FIGS. 15a to 15e in each case a portion of the longitudinal section through a dynamic mixer with rotatable mixing elements and stationary stretching elements;

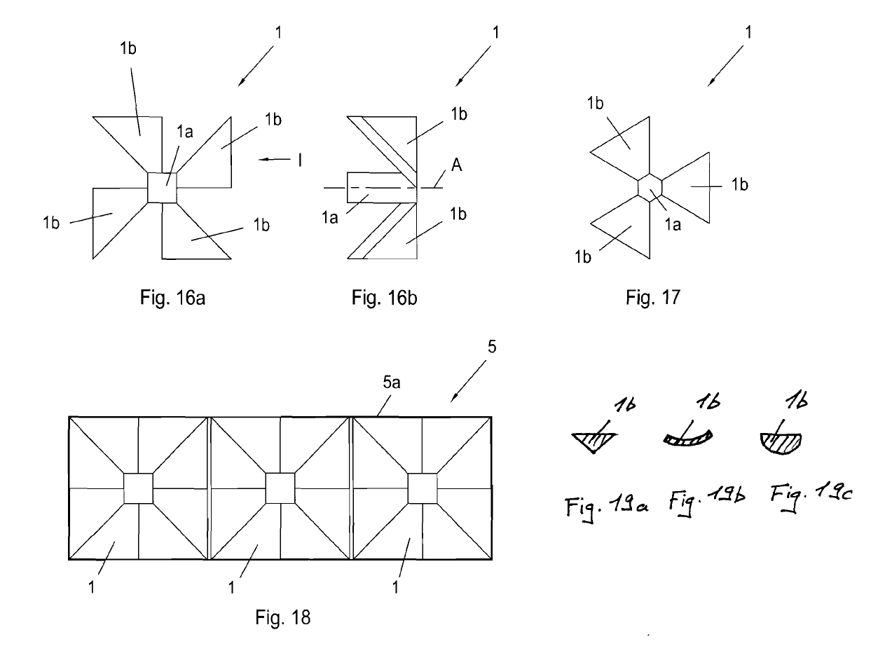

FIG. 16a a view of the front side of a further mixing element;

FIG. 16b a side view of the mixing element in accordance with FIG. 16a;

FIG. 16c a view of the front side of a mixer including a plurality of the mixing elements shown in FIG. 16a;

FIG. 17 a view of the front side of the further mixing element;

FIG. 18 an arrangement of mixing elements in the rectangular flow passage;

FIGS. 19a to 19c cross-sections through different guiding elements.

FIG. 1a shows a view of the front side of a mixing element 1 from the direction of viewing B as shown in FIG. 1b. The mixing element 1 consists of a base body 1a which is axially symmetric with respect to an axis A which, in the illustrated embodiment, is cylindrical and thus of rotationally symmetrical design. Nine guiding elements 1b are arranged uniformly spaced apart in a peripheral direction A1 to the axis A and firmly connected to the base body 1a. The spacing between two guiding elements 1b amounts to the angle γ and the width of a guiding element 1b amounts to the angle β, with the angle β amounting to half the angle γ. The base body 1a has a planar end face 1m extending perpendicular to the axis A with three connecting means 1n being provided at the top, of which the connecting means 1n arranged at the left and the right are formed as a cylindrical bore and the central connecting element 1n is formed as a cylindrically projecting part. At the rear end face 1m three connecting means 1n shown in chain-dotted lines are arranged at the bottom.

FIG. 1b shows a longitudinal section through the mixing element 1 along the section line A-A which, as shown in FIG. 1a, also extends through the cylindrical bore 1n. At the surface 1k facing outwardly with respect to the axis A the guiding elements 1b which extend obliquely to the axis A are arranged in projecting manner. The guiding elements 1b extend with respect to the axis A at an angle α. The guiding elements 1b thus have an inwardly facing guiding surface 1d with respect to the axis A and also an outwardly facing guiding surface 1c with respect to the axis A. Moreover, the connecting means 1m are shown at the two oppositely facing end faces 1m, with both the projecting cylindrical connecting means 1n and also the cylindrical bore 1n being visible at the left.

FIG. 1c shows a view of the rear side of the mixing element 1 as shown in FIG. 1b in the viewing direction C. FIG. 1d shows a perspective view of the rear side of the mixing element 1 and FIG. 1e a perspective view of the front side of the mixing element 1. Furthermore, the cylindrical base body 1a is shown with the axis A and also guiding elements 1b arranged spaced apart in the peripheral direction A1 and at the surface 1k of the base body 1a. The connecting means 1n can be recognized at both end faces 1m. A plurality of mixing elements 1 can be arranged after one another in the axial direction A with contacting end faces 1m such that the connecting means 1n engage into one another so that the mutual position of the individual mixing elements 1 in the peripheral direction A1 is defined.

FIG. 2a shows a view of the rear side of a further embodiment of a mixing element 1. In distinction to the mixing element 1 shown in FIG. 1a the mixing element 1 shown in FIG. 2a has a ring-like support structure 1o which is fixedly connected to the outer ends of the guiding elements 1b. FIG. 2b shows a longitudinal section through the mixing element 1 in accordance with FIG. 2a along the section line D-D. The guiding element 1b has an extent inclined by an angle α with respect to the axis A, with the ends of the guiding element 1b either opening into the base body 1a or into the support structure 1o. Connecting means 1n are arranged at the two oppositely disposed end faces 1m. An advantage of the mixing element shown in FIGS. 2a and 2b is to be seen in the fact that a plurality of such mixing elements 1 can be arranged adjacent one another in the direction of extent of the axis A and mutually contacting one another so that a tubular mixer results, with the support structure 1o forming the outer boundary. The support structure 1o could have sealing means extending in ring-like manner as its end faces 1m, so that two mixing elements 1 arranged adjacent to one another in the direction of the axis A are sealed radially to the axis A in the region of the support structure 1o.

The mixing elements 1 could also be installed without a special seal in a flow passage, for example a tube, with preferably only a small gap existing between the inner wall of the flow passage and the outer diameter of the mixing element 1. The mixing element shown in FIGS. 2a and 2b has the advantage that each individual guiding element 1b is connected at both ends to the support structure, namely in each case both to the base body 1a and also to the ring-like support structure 1o. This arrangement thus has the characteristic that the forces which act during the mixing at the guiding element 1b are distributed at two load dissipating points, inwardly at a base body 1a and outwardly at the support structure 1o. In this way the individual guiding elements 1b can be loaded more without a deformation or indeed destruction occurring. Such guiding elements 1b arranged in this manner can thus withstand larger forces which act both axially in the direction of the longitudinal axis A and also radially to it. Thus a large pressure drop of the fluid in the axial direction is possible without the danger of destruction arising for the guiding elements 1b. Such guiding elements 1b arranged in this way can also be designed with a reduced wall thickness which either reduces the resulting pressure drop for the same fluid through-put or enables a higher fluid throughput for the same pressure drop.

FIG. 3a shows in a perspective view a further embodiment of a mixing element 1. A plurality of guiding elements 1b are in turn arranged at the cylinder-like base body 1a with the axis A in the peripheral direction 1a with adjacent guiding elements 1b in the peripheral direction A1 alternatingly extending at an acute angle and an obtuse angle to the axis A. The guiding elements 1b have in turn outwardly facing guide surfaces 1c with respect to the axis A and inwardly facing guide surfaces 1d with respect to the axis A. The guiding elements 1b have moreover an outer edge 1i. In the illustrated embodiments the general flow direction S of the fluid extends in the direction of the axis A so that the surfaces of the guiding elements 1b designated by 1c and 1d are associated with the leading side whereas the other non-visible surface of these guiding elements 1b are associated with the trailing side. The association to the leading side and to a trailing side naturally depends on the flow direction S.

FIG. 3e shows a development of the surface 1k in a plan view, with the guiding elements 1b being cut in the region of their foot areas 1l. The foot areas 1l of adjacently disposed guiding elements 1b in the peripheral direction A1 are arranged spaced apart in the direction of the axis A so that a transverse opening 1e extending transversely to the axis A is formed between adjacently disposed guiding elements 1b. The guiding element 1b arranged at the top has moreover a triangular flow divider 1f projecting opposite to the flow direction S so that flow takes place at both sides around the guiding element 1b by fluid flowing in the direction S as is shown, which brings about a through-mixing of the fluid in its peripheral direction with respect to the axis A.

FIG. 3b shows a view of the front side of the mixing element 1 shown in FIG. 3a. The guiding elements 1b have side edges extending radially to the axis A, with each guiding element 1b having an angular width β of 30°, so that these side edges appear to lie alongside one another in this view. The guiding elements 1b which have an inwardly directed guiding surface 1d in this view have moreover the visible flow parts 1f. The remaining guiding elements 1b, which do not have any flow divider 1f in the view shown, have an outwardly directing guiding surface 1c. Adjacent guiding elements 1b in the peripheral direction A1 have, as shown in FIGS. 3a and 3e, foot areas 1l which are spaced apart in the direction of the axis A, so that the transverse opening 1e results between two adjacent guiding elements 1b.

FIG. 3c shows a side view of the mixing element 1 in accordance with FIG. 3a. The total length L2 of the mixing element 1 is considerably longer than the total length L1 of the part provided with the guiding surfaces 1b. The mixing element 1 has an outer diameter D2. The base body 1a has an outer diameter D1.

FIG. 3d shows a longitudinal section through the mixing element 1 shown in FIG. 3c along the section line E-E. In this embodiment adjacently disposed guiding elements 1b are fixedly connected together via a web at the point of contact 1h so that a transverse opening 1e bounded by the two neighbouring guiding elements 1b and the surface 1k of the base body 1a forms between a surface 1k and the point of contact 1h. Two neighbouring guiding elements 1b can also only mutually contact one another at the point of contact 1h without a firm connection. The guiding elements 1b can also be made narrower in the peripheral direction A1 so that the neighbouring guiding elements 1b do not contact one another but form a point 1h at a point with the smallest mutual spacing.

FIG. 4a shows a further mixing element 1 which, in distinction to the embodiment of FIG. 3a, has a hollow cylindrical base body 1a. The inner surface of the hollow cylindrical base body 1a could also have a toothed arrangement for example a groove 1q disposed at the inner surface which permits the mixing element 1 to be fixedly connected for example to a stationary or a driven shaft with outer toothing. A plurality of mixing element 1 are preferably arranged following one another in the longitudinal direction on such a shaft with their mutual position, in particular of neighbouring mixing elements, being able to be precisely determined. A shaft of this kind equipped with mixing elements can for example be used as a screw shaft of an extruder. FIG. 4b shows a side view of a mixing element 1 shown in FIGS. 4a and 4c shows a longitudinal section through the mixing element 1 along the section plane F-F.

FIG. 5 shows a longitudinal section along the section plane F-F through a further embodiment of a mixing element 1. Through a corresponding choice of the internal and external diameters D1, D2 and also the lengths L1, L2 the angle of inclination a between the axis A and the direction of extent of the guiding element 1b can be selected depending on the requirements in a range between 10° and 85°.

FIG. 6a shows in a perspective view a support part or stretching part 2 consisting of a hollow cylindrical bearing 2a and a plurality of support arms 2b extending in the radial direction, the cross-section of which can be as desired and which can simultaneously act as stretching elements. FIG. 6b shows a front view of the support part or stretching part 2 and FIG. 6c a section along the section plane G-G. The support part 2 can be fixedly arranged in a further passage 5a and preferably serves as a bearing for a rotatable shaft. The part 2 can however also be fixedly connected to a rotatable shaft so that this part 2 is rotatably arranged within the flow passage 5a and through this rotation brings about an stretching of the fluid in the peripheral direction to the axis A which why this part is termed an stretching part 2. The course of the axis A corresponds to a course of the rotatable shaft.

FIG. 7 shows a longitudinal section of a dynamic mixer 5 including a cylinder-like flow passage 5a, a plurality of bearing parts 2 which are arranged spaced apart in the direction of the axis A and fixedly connected to the flow passage 5a via fastener means 2c, with a plurality of mixing elements 1 disposed alongside one another in the direction of the axis A being rotatably mounted at the bearing positions 1p. The mixing elements 1 are mutually firmly connected together via a non-visible connection means in and thus form an assembled mixing element 3. The assembled mixing element 3 includes a conical cover 3a at both ends between which the individual mixing elements 1 are clamped. The assembled mixing element 3 moreover includes a projecting rotatable shaft 4 at one side which can be set in rotation from the outside. Two inlets 6a, 6b are added to the mixer 5 so that fluid flowing in through these inlets 6a, 6b flows through the mixer and thereafter is supplied to the outlet 6c. In FIG. 7 only the upper part of the assembled mixing element 3 is shown in sectioned form. The rotating mixing elements 1 bring about in particular a rotation of the fluid in the peripheral direction to the axis A with the support parts 2 being fixedly arranged and thus exerting an expanding action in the peripheral direction on the rotating fluid.

The mixer shown in FIG. 7 is in particular suitable as a so-called dynamic inline mixer, in particular for fluids with the most diverse viscosities from gaseous up to highly viscous fluids. The mixer is, for example, for the mixing of reactive resin/hardener systems, for the mixing of components of polyurethane systems, for the preparation of foodstuffs, for the dispersing of liquids with strongly differing viscosities, such as additives in plastic melts or for the dispersing of gases in liquids.

FIG. 8 shows in a longitudinal section a further embodiment of a dynamic mixer 5 wherein, in distinction to the embodiment of FIG. 7, the support parts 2 are likewise designed as mixing elements, for example as shown in FIG. 4a, with these mixing elements 1 being connected firmly to the outer wall of the mixer 5 via fastening means 2c and wherein the assembled mixing element 3 is rotatably mounted in these fixedly arranged mixing elements 1.

FIG. 9 shows, in a longitudinal section, a static mixer having a tubular flow passage 5a in an inner space of which an assembled mixing element 3 is fixedly arranged. The mixing element 3 is fixedly connected via non-illustrated fastener means 2c to the outer wall, i.e. to the flow passage 5a. An advantage of the mixing elements 1 of the invention lies in the fact that these can be assembled in the most diverse manner with spacer elements 7 preferably additionally being used, which are for example of cylindrical shape and have the same connecting positions 1n as the mixing element 1. Such mixing elements 1 are in particular suitable for use as a set of components in order to manufacture mixers 5 with the most diversely designed assembled mixing elements 3. FIG. 9 shows with reference to a plurality of embodiments how a mixing element 3 can be assembled by different combinations of mixing elements 1 and eventually using spacer elements 7.

The FIGS. 10 to 13 show the section 5b from a view in the direction of the section line H-H. Depending on the design of the mixing elements 1 arranged at the right and at the left within a portion 5b different cross-sections result. In FIG. 10 each mixing element 6 has guiding elements 1b which have an angular width β of 30° in each case, with adjacent guiding elements 1b in the peripheral direction A1 being offset by 30°. The two mixing elements 1 are arranged offset in the peripheral direction A1 so that the guiding elements 1b are arranged similar to the manner shown in FIG. 3b. In the portion 5b a spacer element 7 is arranged between the mixing elements 1. The mixing elements 1 could also be arranged mutually contacting at their end faces in shown in FIG. 5c without the use of a spacer element 7, with the guiding elements 1b of the one mixing element 1 coming into lie in the intermediate spaces of the other mixing element 1, if the base bodies 1a are made correspondingly shorter, as shown. The mixing element 1 arranged in the portion 5c could also be made in one piece, as shown in FIG. 3a.

The guiding elements 1b could also have side ends extending in parallel as is shown in section in accordance with FIG. 11, with all the guiding elements 1b of the two mixing elements 1 having the same width in the peripheral direction A1 in this embodiment.

Differently designed mixing elements 1 can also be combined as desired in the portion 5b. In the section in accordance with FIG. 12 the one mixing element 1 is designed as shown in FIG. 10 or the other mixing element 1 is designed as shown in FIG. 11 so that their arrangement results in the sectional view shown in the portion 5b in accordance with FIG. 12.

Two mixing elements 1, in particular two identical mixing elements 1 could be arranged mutually offset in the peripheral direction A1 as is shown in the sectional view in accordance with FIG. 13 in which the two mixing elements 1 shown in FIG. 10 are mutually rotated in the direction A1, for example in such a way that the mixing element 1 with the guiding elements 9 shown at the left in the portion 5b retains its position whereas the mixing element 1 shown at the right in the portion 5b with guiding element 8 is rotated in the direction A1 so that, from the view of the section plane H-H, a part of the guiding element 8 comes to lie behind the guiding element 9.

FIG. 14a shows a mixer 5 with a cylindrical flow passage 5a in a longitudinal section, with two mixing elements 1 being arranged on the rotatable shaft 4 and with the rotatable shaft 4 being rotatably journalled via a bearing part 2 and/or an stretching part 2. The bearing part 2 or stretching part 2 can be firmly connected to the flow passage 5a with the aid of a fastener means 2c, for example a bolt. The support arms 2b of the bearing part 2 can however also be pressed against the inner surface of the flow passage 5a and be firmly held in this manner. In the longitudinal sections in accordance with the FIGS. 14b and 14c the bearing parts 2 are designed as mixing elements 1, for example as shown in FIG. 4a or 4c. These bearing parts 2 or stretching parts 2 are connected via fastener means 2c firmly to the flow passage 5a.

The FIGS. 15a to 15e show longitudinal sections of mixers 5 having rotatably mounted mixing elements 1. The FIGS. 15a to 15d show stretching elements 10 projecting into the inner space of the flow passage 5a, with the stretching elements for example being of cylindrical or rhomboid shape. The stretching elements 10 can all be designed in the most diverse manner, for example as shown in FIG. 15e, also such that the stretching element 10 has an outer peripherally extending ring on which inwardly projecting guiding elements 10a are arranged. The guiding elements 10a could also extend in crossed manner as shown in FIG. 15e.

FIG. 16a shows the rear side of a further embodiment of a mixing element 1 having an axially symmetric base body 1a with respect to an axis A and projecting guiding elements. FIG. 16b shows the mixing element 1 shown in FIG. 16a in a side view from the direction I.

The FIG. 17 shows the rear side of a further mixing element 1 having a hexagonal basic body 1a and three projecting guiding elements 1b.

FIG. 18 shows a cross-section through a mixer 5 having a rectangular flow passage 5a. Three mixing elements 1 are arranged in parallel and lie alongside one another in the flow passage 5a. A plurality of further mixing elements 1 could be arranged perpendicular to the plane of illustration behind the visible mixing elements 1.

The FIGS. 19a to 19c show cross-sections through guiding elements 1b. The guiding elements 1b can be designed with the most diverse cross-sectional shapes.

The mixing element 1 and the mixer 5 that are shown are suitable for the mixing, homogenisation and dispersing of a plurality of fluids, in particular also for melt homogenisation during injection moulding or extrusion. The mixing elements 1 and the mixer 5 are thus also suitable for use as mixing parts on screws of extruders, for example for the processing of plastics or of foodstuffs or for injection moulding machines. The mixing elements 1 and the mixer 5 could also be installed in the back-flow locks of injection moulding machines and supplement the function of this machine part by the mixing function. The mixers 5 in accordance with the invention can also be used when the fluid to be mixed is subjected to larger alternating loads, since larger forces can be mutually transmitted between the individual mixing elements 1 via their end faces 1m.

The pressure drop across a mixing element 1 can in particular also be influenced by the angle of inclination α of the guiding element 1b. In order to achieve a smaller pressure drop the angle of inclination α is selected to be correspondingly smaller. Accordingly, a larger angle of inclination α leads to a larger pressure drop. The pressure drop can also be influenced by corresponding choice of the length of a mixing element 1 in the axial direction A or by a corresponding choice of the form of the guiding elements 1b or a corresponding width β of the guiding elements 1b.

The mixing elements 1 can be manufactured of the most diverse materials, for example of metal or plastic. They can be manufactured or assembled by means of suitable casting processes, from full material by means of chip forming processes, by means of electro-erosion or laser-cutting processes, by reshaping or by assembly from individual moulded parts which are manufactured or assembled by welding, soldering, adhesive bonding, by interlocking or by other suitable joining processes. Through the modular assembly of the mixers from individual mixing elements this can be simply dismantled as required, for example for cleaning or for inspection.

The mixer in accordance with the invention enables, dependent on its design, a static mixing or a dynamic mixing if movable rotatable parts are used. In static mixing the mixing process takes place by progressive splitting up of the fluid flow into part flows which are turned over and then put together again. The turning over can in this connection take place essentially radially to the axis A or in the peripheral direction of the axis A. A distributive mixing process. Limits are placed on this mixing process, for example in dispersing tasks, in which the required energy input rises greatly when fine dispersions are to be produced. For such applications it is more advantageous to use a mixing method which is based on the principle of a stretching of the fluid flow which enables a substantially better mixing for a smaller energy requirement. The dynamic mixer described, for example in FIGS. 7 and 8 unites the two mixing principles dividing (and stretching in an ideal manner).

In an advantageous method for the mixing of a flowing substance in a flow passage having a longitudinal axis A the flowing material is distributed with a static mixing element both in the radial direction and also in the peripheral direction with respect to the longitudinal axis A and the flowing material is expanded in the peripheral direction with a dynamic mixing element 2 which is rotated about the longitudinal axis A. In a further advantageous method step the dynamic mixing element distributes the flowing material with respect to the longitudinal axis A at least in one of the two directions: radial direction and peripheral direction.

Depending on the degree of difficulty of the mixing task and the requirements placed on the degree of homogeneity of the mixture which is to be achieved, between 1 to 100 mixing elements arranged behind one another are required, if necessary even more.

1-21. (canceled)

22. A mixing element (1) for inversion and mixing of flowing materials in a flow channel, comprising an axially symmetrical base body (1a) having a longitudinal axis (A), wherein the base body (1a) has a surface (1k) facing outwardly with respect to the longitudinal axis (A) and respective end faces (1m) at each end of the longitudinal axis (A), further comprising a plurality of guiding elements (1b) that are coupled to the base body (1a) at the surface (1k) via a foot area (1l), wherein the guiding elements (1b) extend obliquely to the longitudinal axis (A) so that each guiding element (1b) has an inwardly facing guiding surface (1d) with respect to the longitudinal axis (A) and an outwardly facing guiding surface (1c) with respect to the longitudinal axis (A) and wherein a plurality of guiding elements (1b) are sequentially arranged in circumferential direction (A1) of the longitudinal axis (A).

23. The mixing element of claim 22 wherein the guiding elements (1b) are uniformly spaced in the circumferential direction (A1) and wherein an intermediate space between two guiding elements (1b) corresponds at least to a width of at least one guiding element in the circumferential direction (A1).

24. The mixing element of claim 22 wherein the end faces (1m) have connecting elements (1n) that are configured to allow connecting mixing elements (1) arranged adjacent to one another in the direction of the longitudinal axis (A).

25. The mixing element of claim 24 wherein the connecting elements (1n) comprise a plurality of engagement positions spaced apart in the circumferential direction (A1).

26. The mixing element of claim 22 wherein the guiding elements (1b) have two lateral ends which extend radially to the longitudinal axis (A).

27. The mixing element of claim 22 wherein the guiding elements (1b) have two lateral ends which extend in parallel.

28. The mixing element of claim 22 wherein at least two outer ends of the guiding elements (1b) are coupled to a common support structure (1o).

29. The mixing element of claim 22 wherein neighboring guiding elements (1b) in the circumferential direction (A1) alternatingly extend at an acute angle and at an obtuse angle to the longitudinal axis (A), with in each case two neighboring elements (1b) in the circumferential direction (A1) having foot areas (1l) which are spaced apart in the direction of the longitudinal axis (A).

31. The mixing element of claim 29 wherein two adjacent guiding elements (1b) in the circumferential direction (A1) form a contact point (1h) above the surface (1k) of the base body (1a) so that a transverse opening (1e) bounded by the two neighboring guiding elements (1b) and the surface (1k) of the base body (1a) is formed between the surface (1k) and the point of contact (1h), with an even multiple of guiding elements (1b) being arranged in the circumferential direction (A1).

31. The mixing element of claim 22 wherein the base body (1a) is of cylindrical shape.

32. An apparatus comprising a plurality of mixing elements (1) according to claim 22.

33. The apparatus of claim 32, further comprising a spacer element (7) that has an axially symmetric base body (1a) with end faces (1m), wherein the spacer element (7) is located between two mixing elements (1).

34. The apparatus of claim 32 wherein at least one of a plurality of mixing elements (1) and a plurality of spacer elements (7) are arranged to form a circular support point (1p) in cross-section.

35. A mixer (5) comprising a flow passage (5a) and further comprising at least one of a plurality of mixing elements (1) according to claim 22 and an apparatus according to claim 32.

36. The mixer (5) of claim 35 wherein the plurality of mixing elements (1) is arranged therein on a common carrier.

37. The mixer of claim 36 wherein the mixing elements (1) are rotatably mounted about the longitudinal axis (A).

38. The mixer of claim 37 wherein a support (2) is fixedly coupled to the flow passage (5a) and forms a rotary bearing with mixing elements (1).

39. The mixer of claim 38 wherein the support (2) has a plurality of support arms (2b) extending in the radial direction or wherein the support (2) is fixedly coupled to the common carrier to form an extension element together with the support arms (2b).

40. The mixer of claim 38 wherein the support (2) is formed as mixing elements (1) having a plurality of guiding elements (1b) arranged distributed in circumferential direction (A1).

41. A method for mixing of a flowing material in a flow passage having a longitudinal axis (A) in which flowing material is distributed with respect to the longitudinal axis both in radial direction and in circumferential direction, and wherein the flowing material is further expanded in the circumferential direction with a dynamic mixing element which is rotated about the longitudinal axis (A).

42. The method of claim 41 wherein the dynamic mixing element distributes the flowing material with respect to the longitudinal axis (A) at least in one of the radial direction and the circumferential direction.
